(19) United States
(12) Patent Application Publication
(10) Pub. No.: US 2013/0344467 A1
(43) Pub. Date: Dec. 26, 2013

(54) SYSTEMS AND METHODS FOR PROVIDING COUPLABLE ORNAMENTS

(71) Applicant: Trevor Norcross, Shoreline, WA (US)

(72) Inventor: Trevor Norcross, Shoreline, WA (US)

(73) Assignee: ULTIMATE RECOGNITION, LLC, Shoreline, WA (US)

(21) Appl. No.: 13/528,822

(22) Filed: Jun. 20, 2012

(51) Int. Cl. G09F 19/00; G09B 19/00; A47G 35/00; B32B 1/04; B32B 3/08

(52) U.S. Cl. 434/238; 428/542.2; 428/99; 428/67; 428/131; 428/172; 428/80; 428/7; 428/11; 428/542.4

(57) ABSTRACT

A couplable ornament may be a five-pointed star, a rectangle or other form, and be configured for coupling to other ornaments using a ball-and-socket construction, magnets, tabs and slots or other coupling means. The ornament may have words or designs with significance to an individual or organization, and a plurality of ornaments may be awarded over time with different markings or words where the plurality of ornaments couple with one another. A system of couplable ornaments may be an employee achievement recognition system in which the ornaments are awarded by an organization to employees over time to mark particular individual or organizational milestones, where the ornaments may be coupled together by recipients to form shapes, structures or other designs constructed from the individual ornaments. The ornament may have two halves forming an ornamental member with the ability to receive decorative elements such as a substrate and/or a snap-in ring.

### FIELD OF THE INVENTION

This invention relates generally to ornaments, and more specifically, to systems and methods for providing couplable ornaments.

### BACKGROUND

New opportunities exist for ornaments which couple together. Accordingly, this application discloses systems and methods for providing couplable ornaments.

### SUMMARY

This invention relates generally to ornaments, and more specifically, to systems and methods for providing couplable ornaments.

In some embodiments, an ornament may comprise an ornamental member configured to removably couple with another ornament; and a decorative element fastened to the ornamental member. In some embodiments, the ornament may include one or more protrusions extending from the ornamental member, each protrusion including at least a ball, the ball at an end of the protrusion opposite the ornamental member; and one or more sockets defined within the ornamental member, each socket configured for removably receiving a ball of another ornament. In some embodiments, the one or more protrusions and one or more sockets comprise a ball-and-socket construction for removably coupling a first ornament with at least a second ornament. In some embodiments, the ball-and-socket construction is configured for a first and a second coupled ornament to at least one of rotate, swivel, pivot or articulate relative to one another.

In some embodiments, the ornament may comprise one or more magnets, each magnet configured for removably coupling a first ornament with at least a second ornament. In some embodiments, the ornament may comprise a means for removably coupling a first ornament with at least a second ornament.

In some embodiments, the decorative element fastened to the ornamental member comprises a decorative element that is at least partially embedded within an interior region of the ornamental member. In some embodiments, the decorative element fastened to the ornamental member comprises a substrate, the substrate including a design disposed on at least a first face of the substrate. In some embodiments, the decorative element fastened to the ornamental member comprises a printable surface. In some embodiments, the printable surface is configured for an image to be printed on the printable surface, the image printed on the printable surface subsequent to manufacturing of the ornamental member and decorative element, the image printed on the printable surface prior to fastening the decorative element to the ornamental member, wherein manufacturing of the ornamental member and decorative element occurs at a different location than a location where the image is printed and where the decorative element is fastened to the ornamental member.

In some embodiments, the ornamental member configured to removably couple with another ornament further comprises a front face and a rear face, wherein one or more channels are disposed through the ornamental member, the one or more channels having at least a first aperture disposed through the front face. In some embodiments, the first aperture is configured for receiving one or more of a gem or a shaft of a pin. In some embodiments, the channel is configured for receiving a means for mounting the ornament to a structure.

In some embodiments, the ornament may comprise a snap-in ring, wherein the ornamental member includes a recess configured for removably receiving the snap-in ring. In some embodiments, the ornament may be substantially in the shape of one of a five-pointed star, a four-pointed star, a rectangle, a heart, a triangle, a cross, a hexagon, or a trapezoid. In some embodiments, the ornament is an employee achievement award given by an organization to an employee. In some embodiments, at least one of the ornamental member, the decorative element or the snap-in ring have one or more words disposed on an exterior surface, the one or more words including words embodying values of the organization. In some embodiments, at least a portion of the ornament is manufactured from material used in manufacturing a product distributed by the organization to non-employees.

In some embodiments, a system for rewarding employee achievement comprises a plurality of employee achievement awards, the employee achievement awards comprising one or more ornaments configured to removably interlock with other ornaments, the one or more ornaments including one or more of: words disposed on the ornament, the words including words with special meaning for an organization awarding the employee achievement awards; ornaments manufactured at least partially from material used in manufacturing a product distributed by the organization awarding the employee achievement awards; one or more apertures on a face of the ornament, the one or more apertures configured for receiving one or more of a gem, a shaft of a pin, or a means for mounting the ornament; and/or an interior substrate, the interior substrate including a design having special significance for employees of an organization awarding the employee achievement awards, the interior substrate being at least partially embedded within an ornamental member defining a periphery of the ornament, wherein each of the one or more ornaments includes substantially the same exterior shape, profile and means for removably interlocking with other ornaments.

In some embodiments, a method for rewarding employee achievement, comprises: adopting a system for rewarding employee achievement, wherein the system for rewarding employee achievement includes at least an ornament configured to interlock with other ornaments, wherein the ornament includes aspects with cultural significance for the organization adopting the system for rewarding employee achievement; providing ornaments to one or more employees for one or more of individual achievement, organizational achievement, milestones, or seeding a workforce with an initial award of one or more ornaments; receiving input from one or more employees, the input pertaining to design of one or more aspects of the ornament for future awards; evaluating the input from one or more employees; incorporating selected input from one or more employees in a new ornament, the new ornament maintaining substantially the same exterior shape, profile and means for removably interlocking with other ornaments as previously provided ornaments; and providing new ornaments to one or more employees for one or more of individual achievement, organizational achievement or milestones.

In addition to the foregoing, various other method and/or system aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE DRAWINGS

Embodiments of the present invention are described in detail below with reference to the following drawings:

FIGS. 1a and 1b are a top view and a perspective view of a couplable ornament, in accordance with an embodiment of the invention;

FIGS. 2a, 2b, 2c and 2d are a top view, a top view, a perspective view and a perspective view, respectively, of a plurality of couplable ornaments, in accordance with an embodiment of the invention;

FIGS. 3a, 3b and 3c are a bottom view, a side view and a top view of a half of an ornamental member of a couplable ornament, in accordance with an embodiment of the invention;

FIG. 4 is a perspective view of a decorative element of a couplable ornament, in accordance with an embodiment of the invention;

FIGS. 5a and 5b are a perspective view and a cutaway side view of a snap-in ring of a couplable ornament, in accordance with an embodiment of the invention;

FIG. 6 is an exploded view of a couplable ornament, in accordance with an embodiment of the invention;

FIG. 7 is an exploded view of a couplable ornament, in accordance with an embodiment of the invention;

FIGS. 8a and 8b are a top view of an alternate embodiment of a snap-in ring and a top view of an alternate embodiment of a couplable ornament, in accordance with an embodiment of the invention;

FIGS. 9a and 9b are top views of alternate embodiments of a couplable ornament, in accordance with embodiments of the invention;

FIG. 10 is a top view of coupled alternate embodiments of a couplable ornament, in accordance with embodiments of the invention;

FIGS. 11a and 11b are a top view and a perspective view of a couplable ornament, in accordance with an embodiment of the invention;

FIGS. 12a, 12b, 12c and 12d are various top views of pluralities of couplable ornaments, in accordance with an embodiment of the invention;

FIGS. 13a, 13b, 13c, 13d and 13e are a front view, a rear view, a cutaway side view, a front perspective view and a rear perspective view of a portion of an ornamental member, in accordance with an embodiment of the invention;

FIG. 14 is a perspective view of a decorative element of a couplable ornament, in accordance with an embodiment of the invention;

FIG. 15 is a perspective view of a snap-in ring of a couplable ornament, in accordance with an embodiment of the invention;

FIGS. 16a, 16b and 16c are various exploded views of portions of a couplable ornament, in accordance with an embodiment of the invention;

FIGS. 17a, 17b, 17c and 17d are various views of pluralities of various embodiments of couplable ornaments, in accordance with varied embodiments of the invention;

FIG. 18 is a perspective view of a plurality of couplable ornaments, in accordance with an embodiment of the invention;

FIG. 19 is a system diagram of a system for rewarding employee achievement, in accordance with an embodiment of the invention; and

FIG. 20 is a flow diagram of a method for rewarding employee achievement, in accordance with an embodiment of the invention.

### DETAILED DESCRIPTION

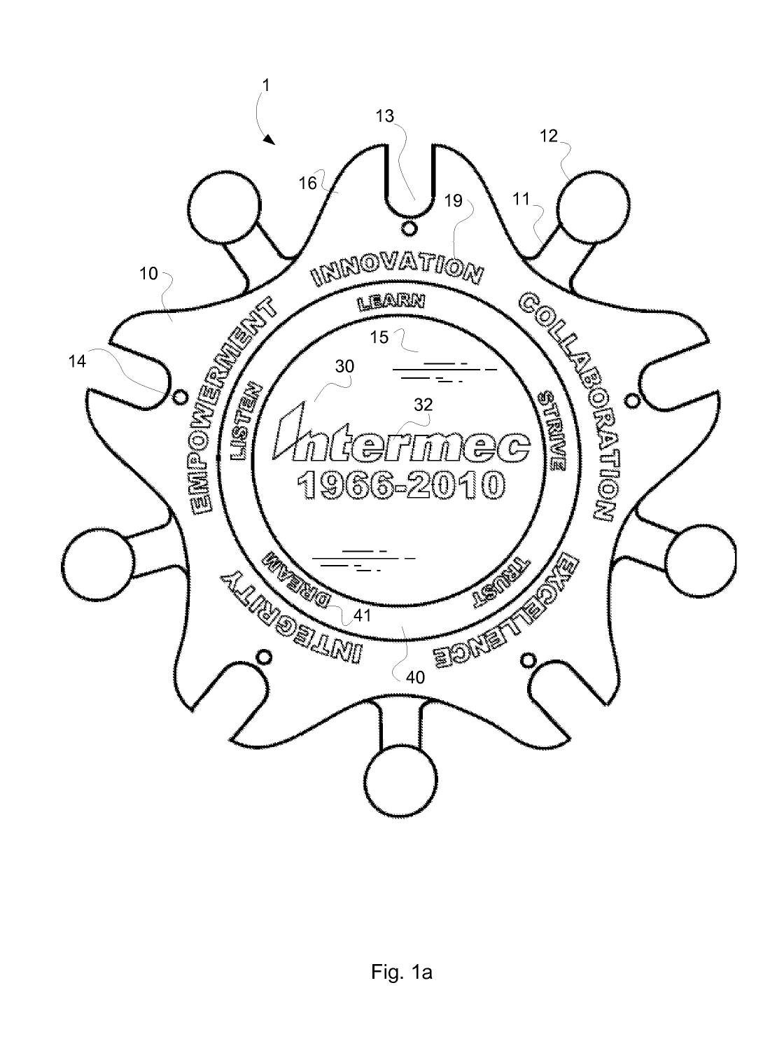

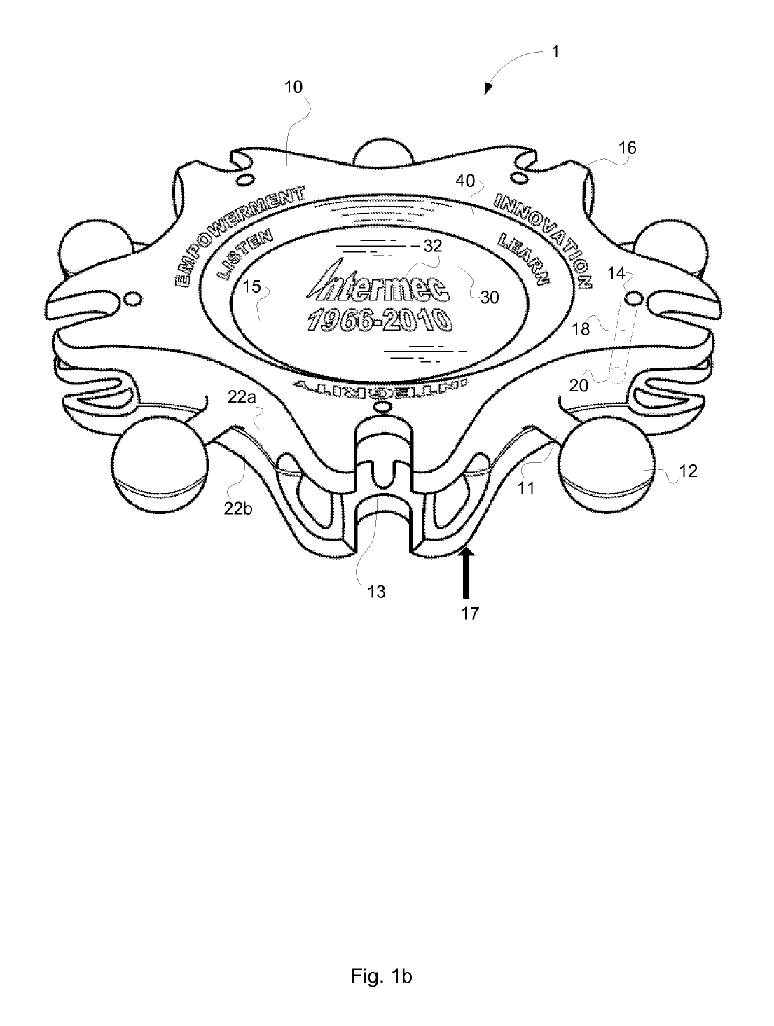

This invention relates generally to ornaments, and more specifically, to systems and methods for providing couplable ornaments. Specific details of certain embodiments of the invention are set forth in the following description and FIGS. 1-20 and the APPENDIX to provide a thorough understanding of such embodiments. The present invention may have additional embodiments, may be practiced without one or more of the details described for any particular described embodiment, or may have any detail described for one particular embodiment practiced with any other detail described for another embodiment.

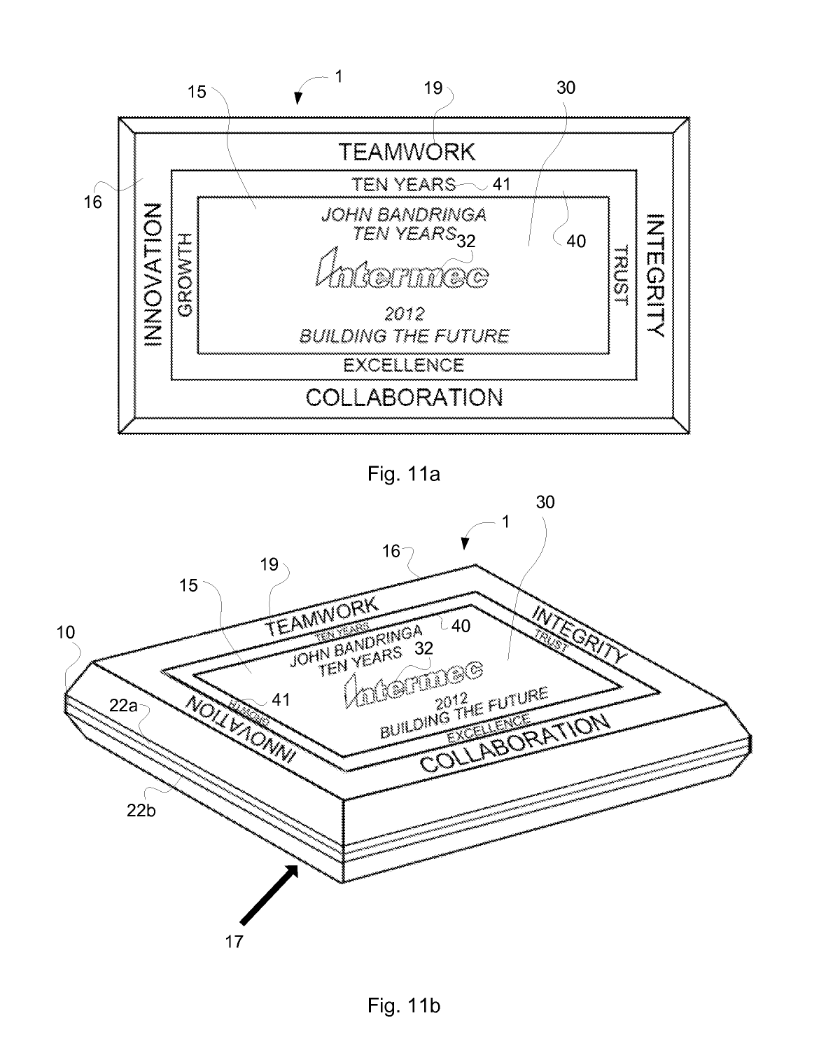

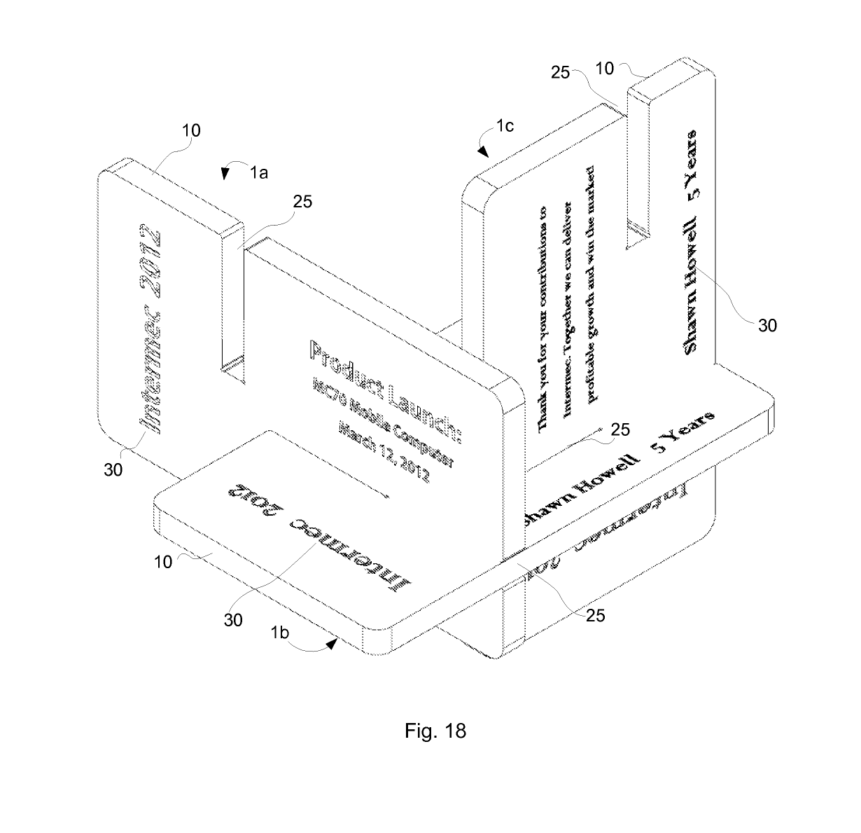

FIGS. 1a and 1b are a top view and a perspective view of a couplable ornament, in accordance with an embodiment of the invention. FIGS. 11a and 11b are a top view and a perspective view of a couplable ornament, in accordance with an embodiment of the invention. FIGS. 17a, 17b, 17c and 17d are various views of pluralities of various embodiments of couplable ornaments, in accordance with varied embodiments of the invention. FIG. 18 is a perspective view of a plurality of couplable ornaments, in accordance with an embodiment of the invention.

In some embodiments, a couplable ornament 1 may be substantially in the shape of one of a five-pointed star, a four-pointed star, a rectangle, a heart, a triangle, a cross, a hexagon, or a trapezoid. In different embodiments, a couplable ornament may take on a different shape, wherein a plurality of ornaments have a similar shape and substantially similar means of coupling the ornament, wherein a plurality of ornaments may be coupled and shapes or designs may be formed from the plurality of ornaments. For example, a “ball-and-socket” type ornament may couple with other ball-and-socket ornaments, whether the other ball-and-socket ornaments have the same physical geometry (i.e. five-pointed stars coupling with other five-pointed stars) or the other ball-and-socket ornaments have different physical geometry (i.e. five-pointed stars coupling with four-pointed stars or heart-shaped ornaments). In some embodiments, an ornament may have one means of coupling, or may have multiple means of coupling, for example a ball-and-socket construction and a plurality of channels through which string or wire may be threaded for coupling ornaments, or a ball-and-socket construction and magnets.

In some embodiments, a couplable ornament 1 may be comprised of an ornamental member 10 and a decorative element 30, where the decorative element is fastened to the ornamental member. In some embodiments, the decorative element may be at least partially embedded within an interior region 15 of the ornament member, as is shown, for example, in FIGS. 1a and 11a. The interior region of the ornamental member may be an opening, hollow, void, channel, aperture or other area in which a decorative element may be visible within the ornament. In different embodiments, the decorative element may be a region of the ornamental member, as is shown, for example, in FIG. 18. In some embodiments, an ornamental member 10 may be comprised of two halves of the ornamental member 22a and 22b.

In some embodiments, two halves of the ornamental member 22 may be identical. In different embodiments, the ornamental member may be constructed of differently-shaped components, or may be one piece.

In some embodiments, an ornament 1 may have a snap-in ring 40. The snap-in ring may couple with another element of the ornament, such as the ornamental member 10 or the decorative element 30. In some embodiments, a snap-in ring may be circular in shape. In different embodiments, a snap-in ring may be rectangular, square or triangular. In varied embodiments, a snap-in ring may have different numbers of sides up to 20 sides.

In some embodiments, an ornament 1 may have components which are decorated, adorned, printed, engraved, designed, or otherwise have visually appealing aspects particular to the ornaments. In some embodiments, the ornament may have a plurality of words. The words may be stamped, tooled, engraved, screened, printed, inked, adhered, stenciled, or otherwise applied to the ornament by other means. In other embodiments, the ornament may have graphic designs applied using the foregoing processes or different processes. In some embodiments, the words may be applied to the ornamental member as shown at 19, the decorative element as shown at 32 or the snap-in ring as shown at 41. In place of the words may be any graphic design that is visually appealing or that has special meaning.

In some embodiments, the decorative element 30 fastened to the ornamental member 10 may be a substrate, the substrate including a design 32 disposed on at least a first face of the substrate. In some embodiments, the design disposed on at least a first face of the substrate includes words, logos, images, or other graphic elements. In some embodiments, the substrate may be a material in which a design may be engraved, embossed, or applied using a different process such as any imaging process disclosed elsewhere herein. In different embodiments, the substrate may be a printable surface. In some embodiments, the printable surface is configured for an image to be printed on the printable surface, the image printed on the printable surface subsequent to manufacturing of the ornamental member 10 and decorative element, the image printed on the printable surface prior to fastening the decorative element to the ornamental member, and wherein manufacturing of the ornamental member and decorative element occurs at a different location than a location where the image is printed and where the decorative element is fastened to the ornamental member. For example, the ornament 1 may be provided as a kit including the ornamental member that is disassembled into halves and the decorative element having a surface on which the design can subsequently be applied, enabling a degree of customization of the ornaments to occur at a site other than the manufacturing location for the components. In different embodiments, words or designs may be applied to other components of the ornament post-manufacturing and distribution of the kit, such as the ornamental member or snap-in ring. In some embodiments, the ornament is an employee achievement award given by an organization to an employee. In some embodiments, at least one of the ornamental member, the decorative element or the snap-in ring have one or more words disposed on an exterior surface, the one or more words including words embodying values of the organization.

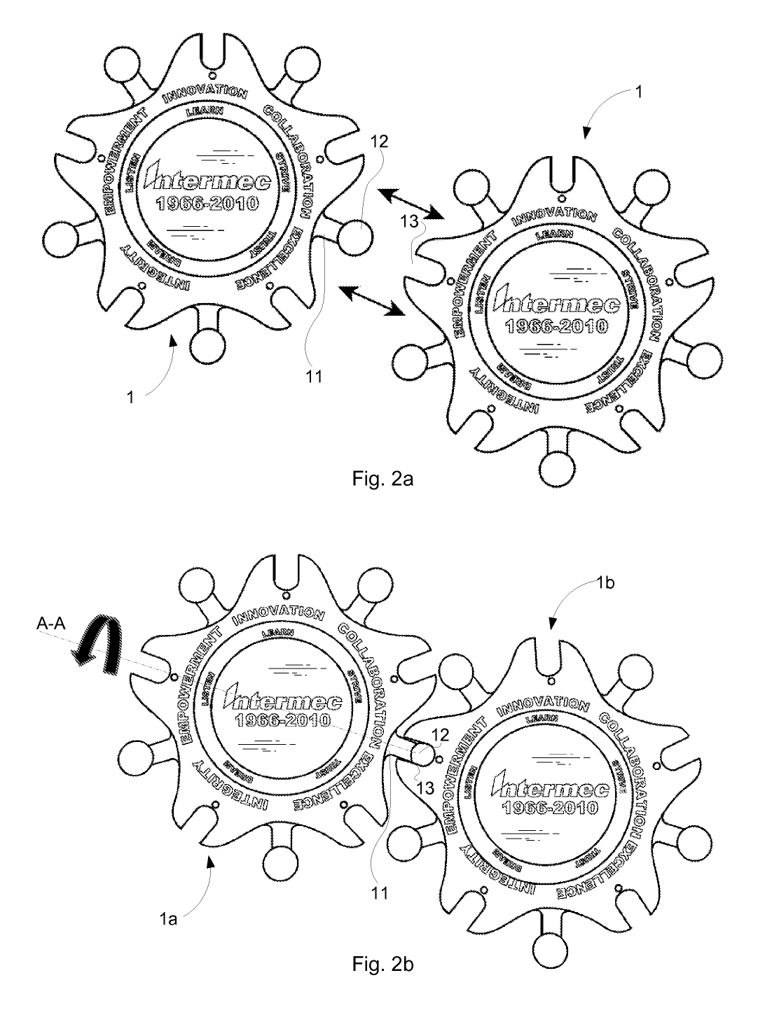

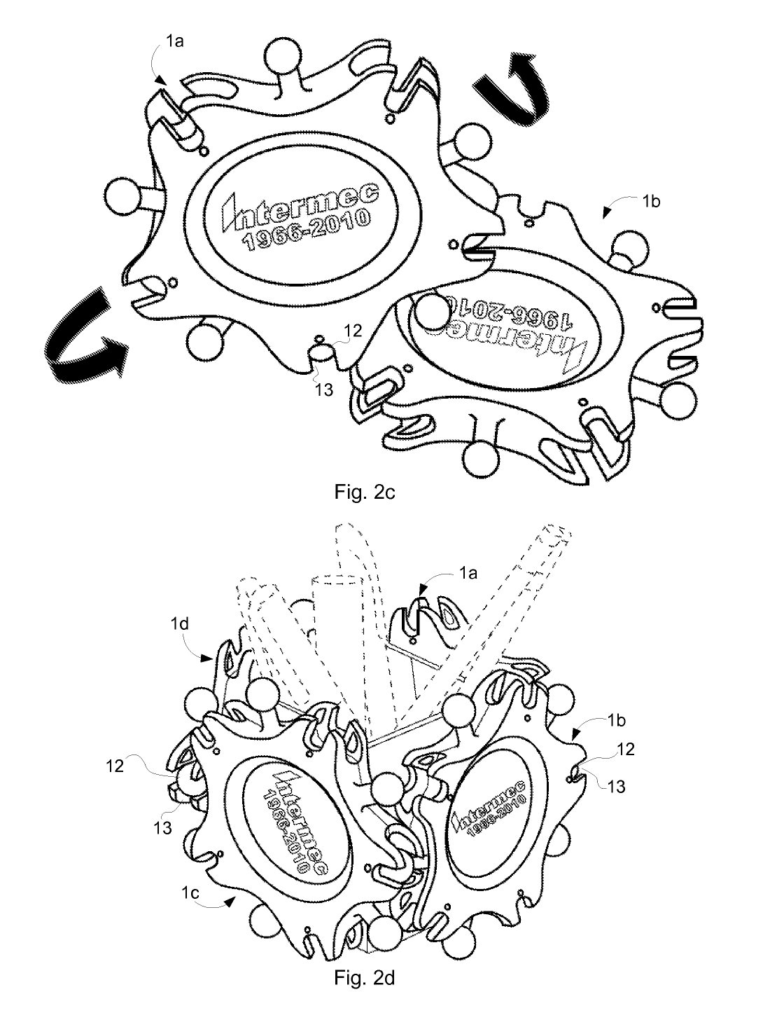

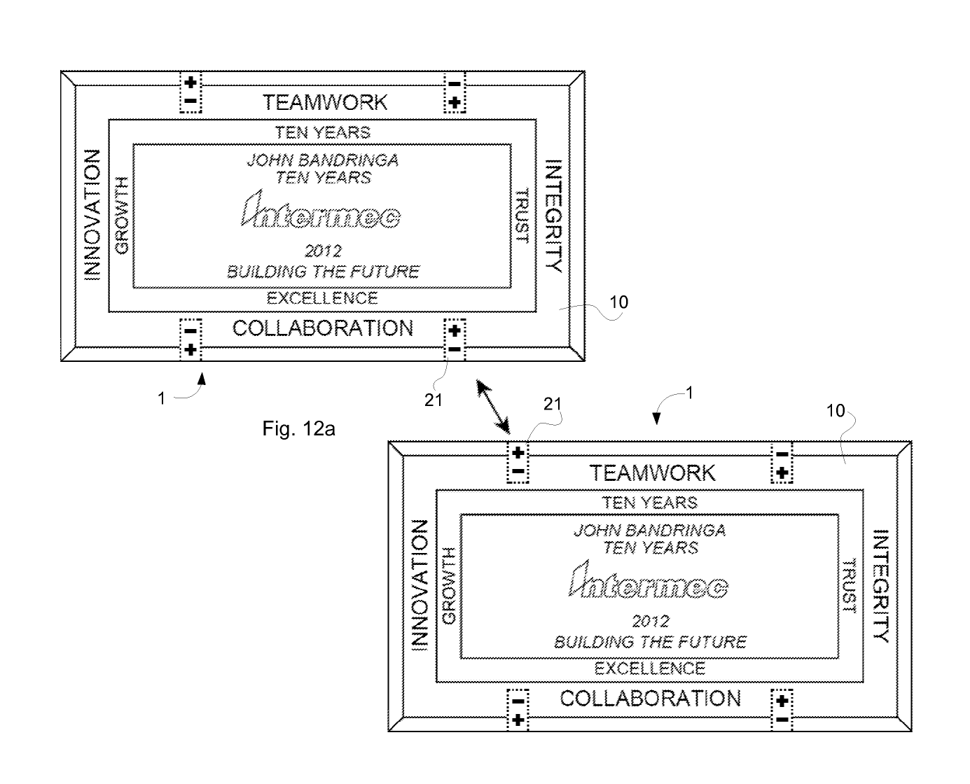

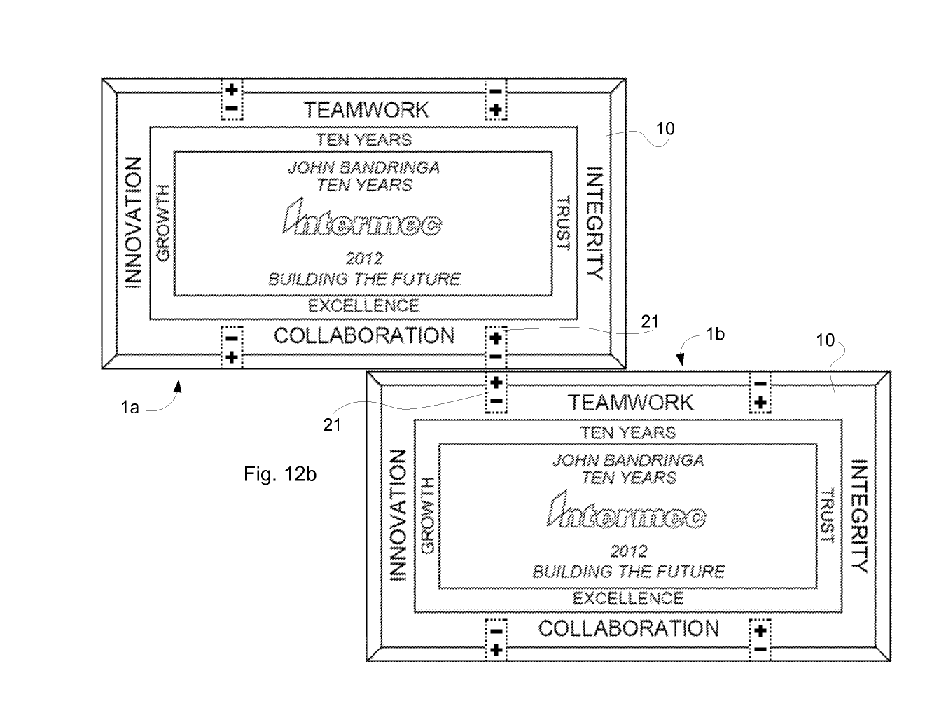

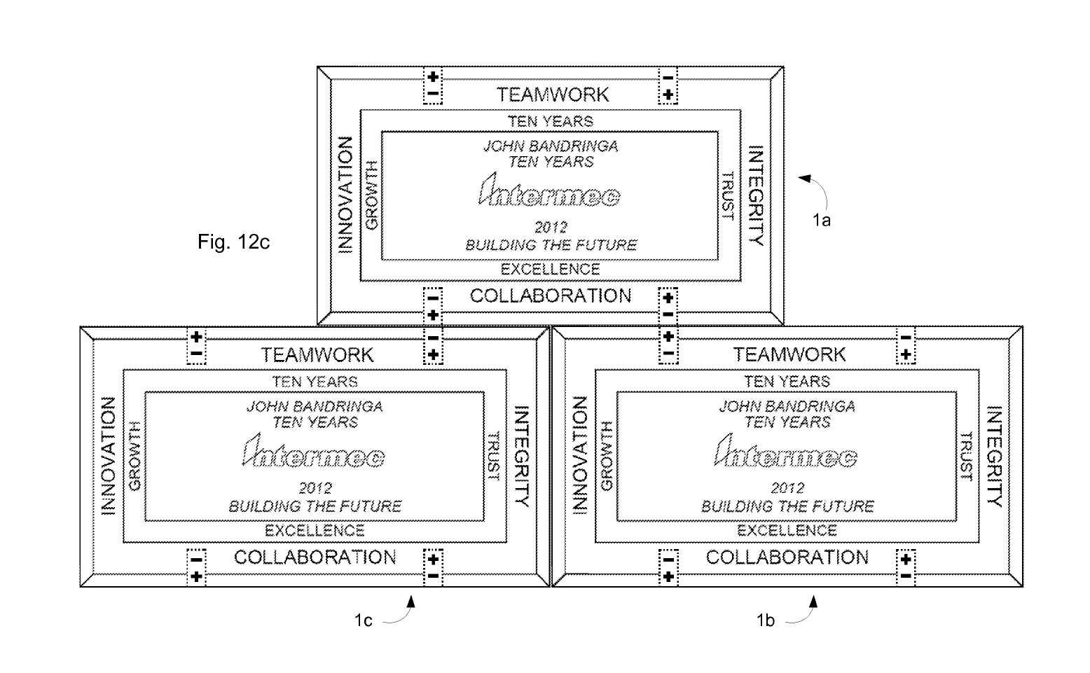

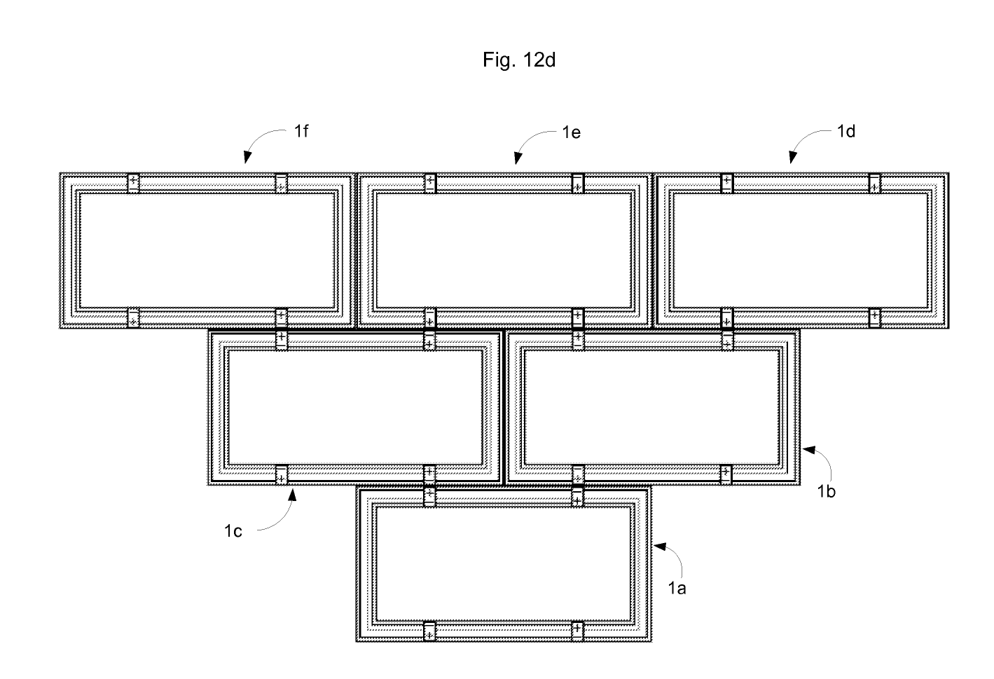

In some embodiments, an ornament 1 is configured for coupling with another ornament 1, such that a plurality of ornaments may be coupled together to form a whole. In some embodiments, the ornaments are configured for removably coupling with one another. In some embodiments, the coupling may be accomplished by pushing ornaments together using features of the ornament as may be seen in FIGS. 2a and 2b and FIGS. 12a-12d. The features of the ornament may also facilitate removing ornaments from the coupling, permitting the ornaments to be connected and disconnected. In some embodiments, the coupling and de-coupling (connecting and disconnecting) may be accomplished by hand with a light amount of force. In other embodiments, the coupling is semi-permanent or permanent. In different embodiments, the coupling and de-coupling may require hand tools, adhesives, solvents, or other means of making or breaking a more permanent connection. In different embodiments, the ornaments may slide into place and be connected such that only the force of gravity holds them together.

In some embodiments, an ornamental member 10 has one or more protrusions 11 extending from the ornamental member, the one or more protrusions having a ball 12 at an end of a protrusion opposite the ornamental member, for example in the embodiment depicted in FIGS. 1a and 1b. In some embodiments, an ornamental member has one or more sockets 13, the socket configured for removably receiving a ball of a different ornament. The socket may be configured such that two ornaments may be pushed together by inserting a ball of a first ornament in a socket of the second ornament and lightly pushing them together, such that a ball snaps into place in the socket. The ornament may be constructed so that portions of the socket deflect slightly, permitting the ball to pass into the socket, with the portions of the socket returning into position once the ball is snapped into the socket. The ornaments may be pulled apart using a light force, sufficient to deflect the portions of the socket that grip the ball and allowing the ball to pass out of the socket. The socket may be configured for receiving the ball by having a prong portion of the socket that slightly overlaps the ball for retaining the ball when the ball is resident in the socket.

In some embodiments, different components of the ornament are configured with a coupling mechanism for coupling to another ornament. The decorative element or snap-in ring may, for example, provide the coupling mechanism.

In different embodiments, coupling of ornaments is achieved magnetically, for example in the embodiment depicted in FIGS. 11a and 11b, and FIGS. 17a-17d. In such embodiments, the ornamental member 10 may have one or more magnets embedded within the ornamental member 10, as may be seen in FIGS. 12a-12d. The magnets may be oriented within the ornamental member in positions permitting ornaments to couple with other ornaments by pushing them together. The ornaments may be pulled apart using a light force. In some embodiments, the ornaments 1a, 1b, 1c . . . 1n may be coupled to form a plurality of ornaments 100 (as may be seen in FIGS. 17a-17d or 12a-12d).

In some embodiments, as may be seen in FIGS. 1a and 1b, an ornament 1 may have one or more channels 14 disposed through the ornament. In some embodiments, the ornamental member of the ornament has a front face 16 and a rear face 17, where in the channel is disposed through the ornamental member. In some embodiments, the channel opens at an aperture disposed through the front face. In other embodiments, the channel opens at an aperture disposed through the rear face. In some embodiments, the channel has apertures in both the front and rear faces, such that the channel is configured for receiving string or wire or other objects or means to pass completely through the ornament, which may in some embodiments include a means for mounting the ornament to a structure. In some embodiments, a front aperture is configured for receiving a gem, or a shaft of a pin.

In still other embodiments, removable coupling of ornaments is achieved through tabs and slots, for example in the embodiment depicted in FIG. 18. In yet other embodiments, ornaments are coupled, removably or otherwise, using fasteners, threaded fasteners, notches, knobs, snaps, latches, grooves, studs, hollows, string, thread, rope, cable, wire, adhesives, joints, bonds, carriers, welds, melting, staples, tongue-and-groove, or other means of coupling.

In different embodiments, the ornament may have components which are made of differing materials, may be colored differently, may have varying degrees of transparency, and may have different properties such as a magnetic property, a particular tactile feel, or a particular odor or taste. In some embodiments, different ornaments may have different appearances or provide different sensations through selection of different ornamental members, decorative elements or snap-in rings that exhibit the different properties. For example, different colored snap-in rings might be available such that the decorative element is the same for every ornament, but that a blue or red snap-in ring could be selected for variety. Snap-in rings having different words may also be selected for variety, as could decorative elements having different designs. In one embodiment, the ornament is made of interchangeable ornamental members, decorative elements and snap-in rings, enabling an ornament to be customizable with respect to the varied ornamental members, decorative elements and snap-in rings. In some embodiments, at least a portion of the ornament is manufactured from material used in manufacturing a product distributed by an organization to non-employees of the organization. For example, an ornament may be an employee achievement award distributed by a company, wherein the ornaments are manufactured of a material predominant in manufacturing of a product sold by the company.

FIGS. 2a, 2b, 2c and 2d are a top view, a top view, a perspective view and a perspective view, respectively, of a plurality of couplable ornaments, in accordance with an embodiment of the invention. FIGS. 12a, 12b, 12c and 12d are various top views of pluralities of couplable ornaments, in accordance with an embodiment of the invention. In some embodiments, a plurality of ornaments 1 can be coupled. In some embodiments, such as the embodiment depicted in FIGS. 2a-2d, the ornament comprises a ball-and-socket construction for removably coupling a first ornament with at least a second ornament. In some embodiments, the ball-and-socket construction is configured for a first and a second coupled ornament to at least one of rotate, swivel, pivot or articulate relative to one another. As may be seen in FIG. 2b, an ornament la may be rotated about an axis AA which extends from the mated ball and socket (the ball 12 of ornament la and socket 13 of ornament 1b) through an axis disposed longitudinally through the protrusion 11 of ornament 1a and through the center of the ornament 1a. As may be seen in FIG. 2c, the ornament 1a may also swivel or pivot or articulate in different directions and rotations relative to the ornament 1b. A plurality of ornaments may be joined together as is shown in FIG. 2d, permitting structures or other designs to be constructed using the ornament (here, four ornaments 1a-1d surrounding a pencil cup holding writing instruments and other office tools).

In different embodiments, such as the embodiment depicted in FIGS. 12a-12d, the ornaments removably couple and de-couple through the use of one or more magnets 21 embedded within the ornamental member 10, each magnet configured for removably coupling a first ornament with at least a second ornament. For example, the magnets may be configured as depicted in dashed lines in FIGS. 12a-12c. The magnets may be embedded in any location in the ornamental member facilitating coupling ornaments with other ornaments. In one embodiment, an ornament 1 may have a generally rectangular appearance, with magnets 21 embedded along the top edge and bottom edge of the ornamental member 10 at ¼ and ¾ lengths across the bottom and top edges, with alternating positive and negative polarities of the embedded magnets. In this fashion, the ornaments may couple in a pyramid configuration, as can be seen in FIGS. 12b-12d. Other magnet position and polarity configurations are possible for providing different coupling mechanisms for the ornaments, and all such positions and configurations are within the scope of the instant disclosure. In different embodiments, the magnets are embedded within a different component (i.e. the decorative element or the snap-in ring) of the ornament. In still other embodiments, the magnets are at least partially exposed or are on a surface of the ornament.

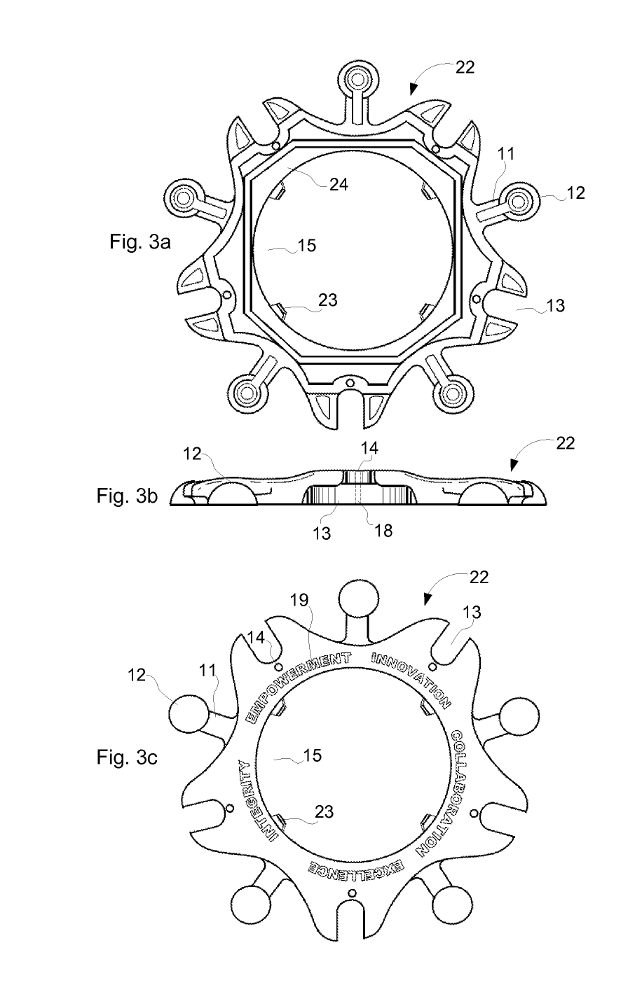

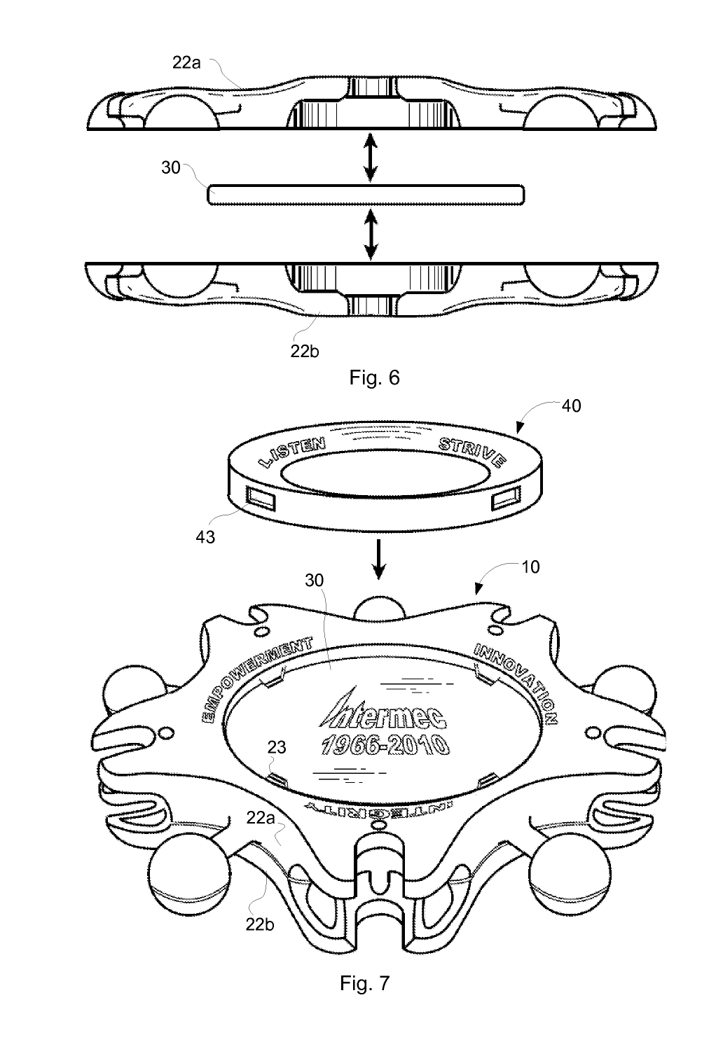

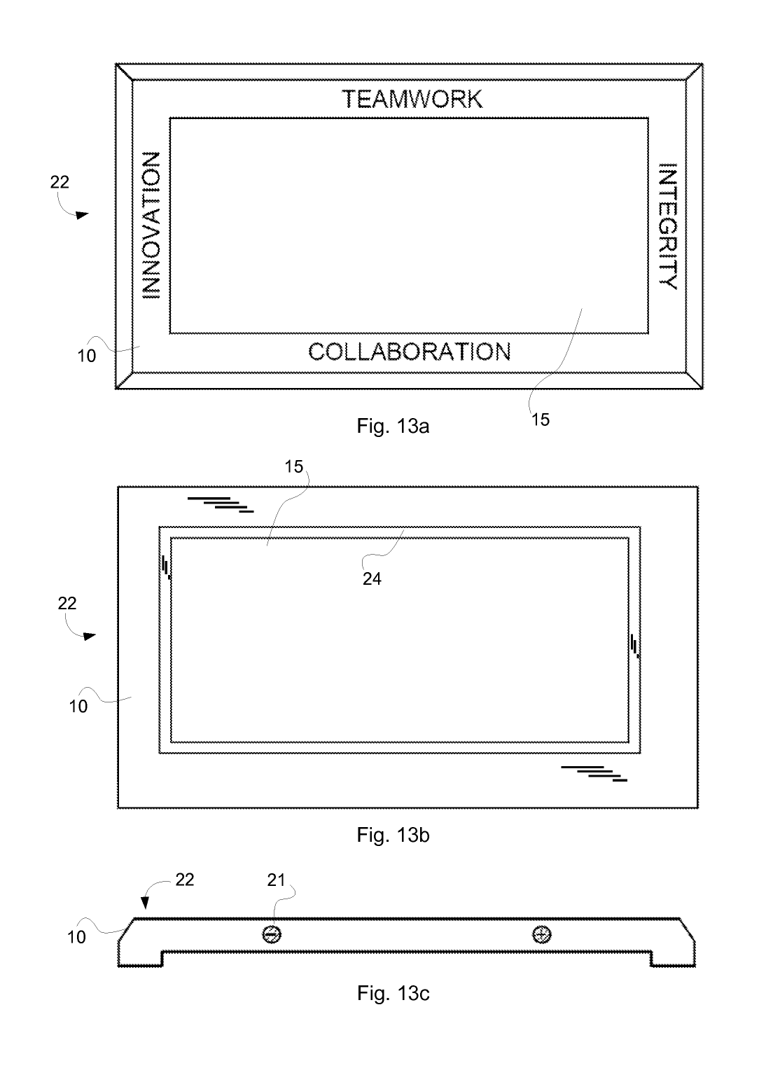

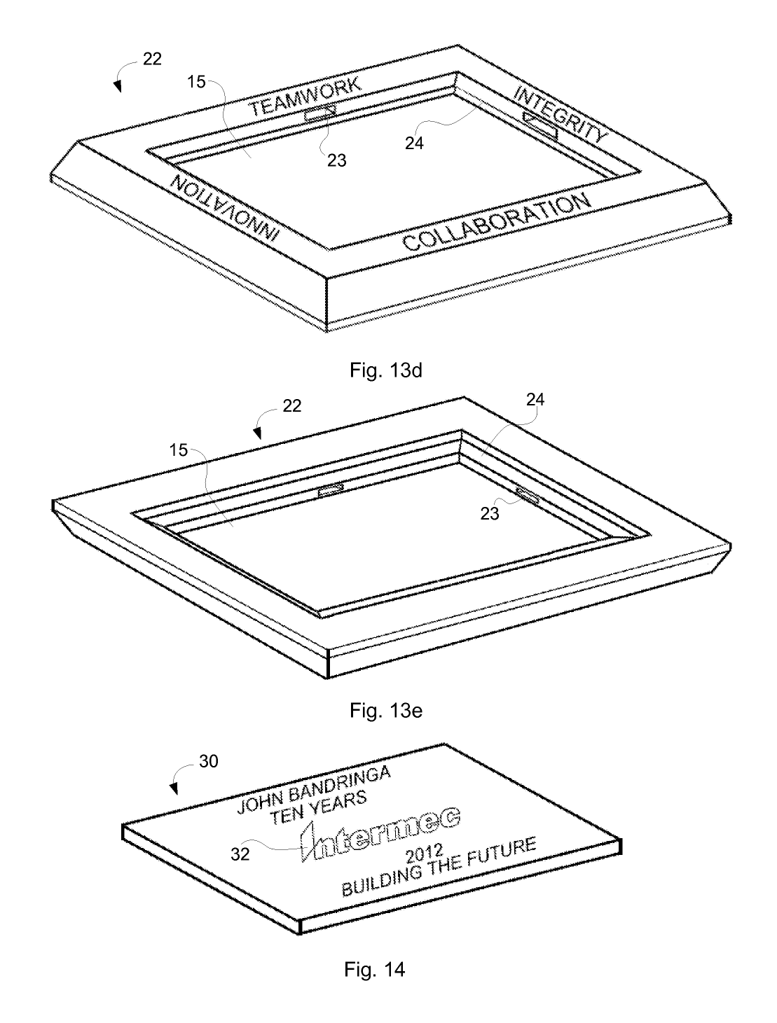

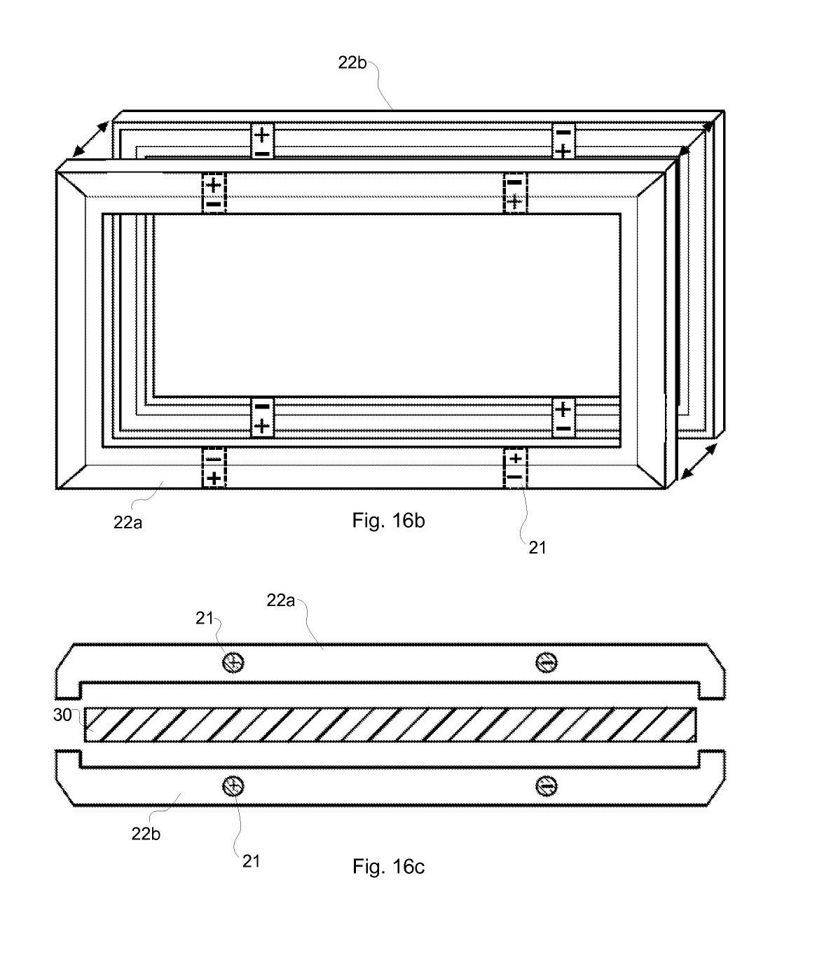

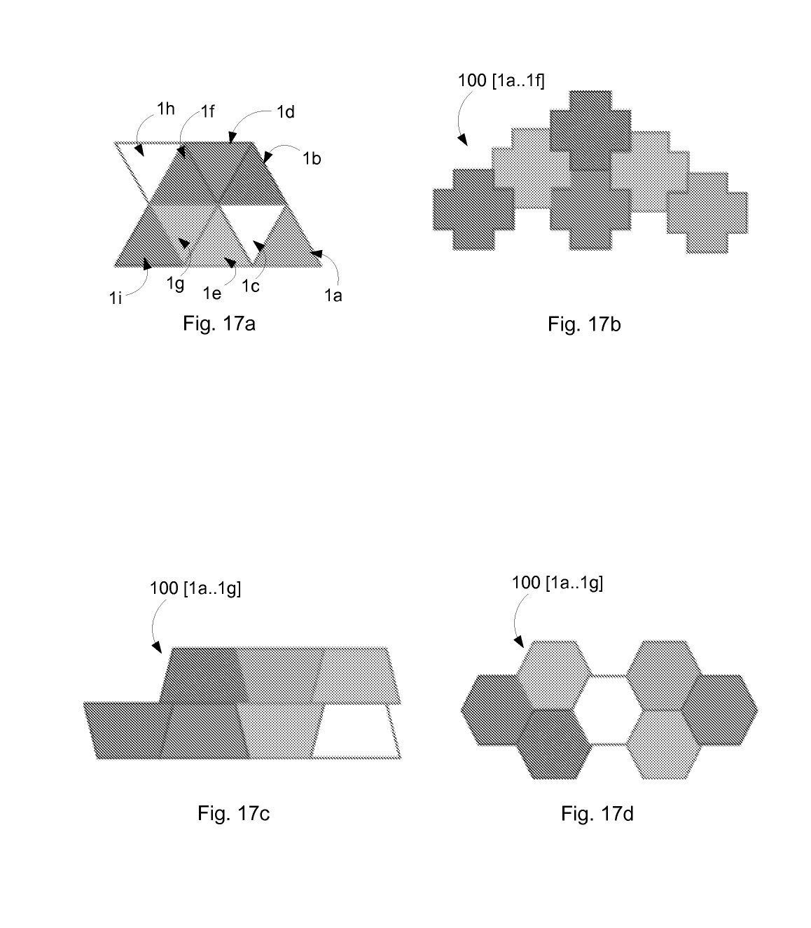

FIGS. 3a, 3b and 3c are a bottom view, a side view and a top view of a half of an ornamental member of a couplable ornament, in accordance with an embodiment of the invention. FIGS. 13a, 13b, 13c, 13d and 13e are a front view, a rear view, a cutaway side view, a front perspective view and a rear perspective view of a portion of an ornamental member, in accordance with an embodiment of the invention. In some embodiments, an ornamental member is comprised of two halves of the ornamental member 22. (In drawings depicting an individual half of the ornamental member, such as FIGS. 3a and 13a, the item is numbered 22. In drawings showing two halves of the ornamental member together forming an ornamental member 10, the halves are numbered 22a and 22b, as shown in FIGS. 1b and 11b.) In some embodiments, two halves of the ornamental member are coupled together with a decorative element 30 sandwiched in between the halves, as can be seen in FIGS. 6 and 16a.

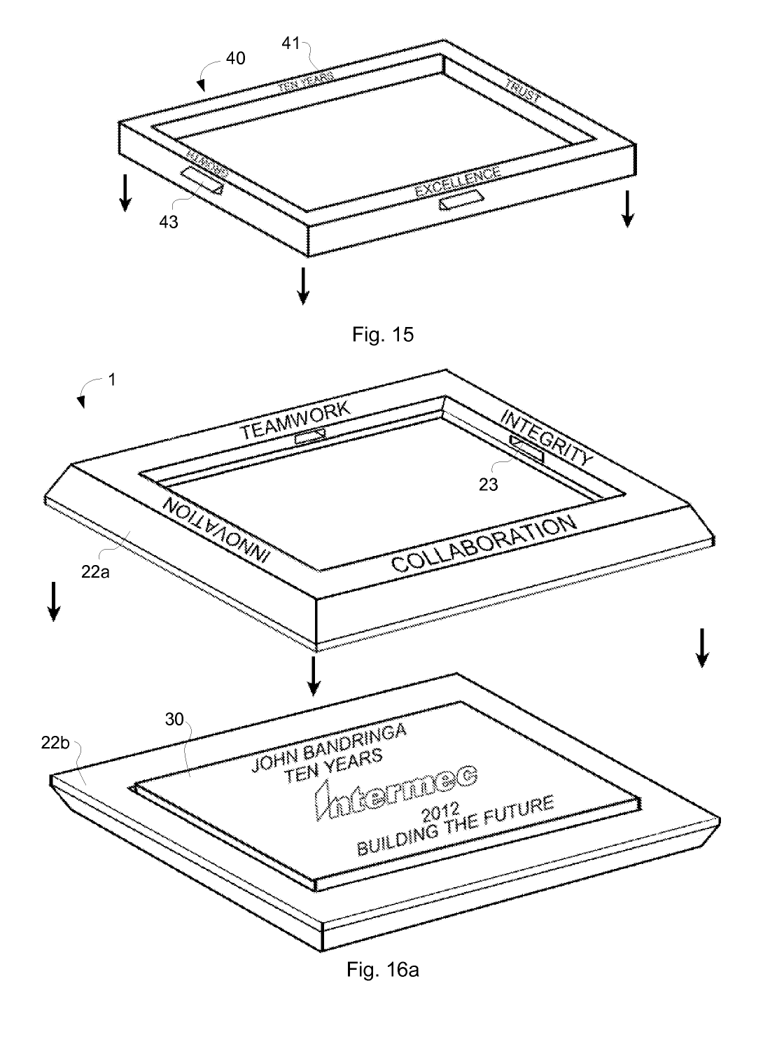

Returning to FIGS. 3a and 13a, in some embodiments, the half of an ornamental member 22 has an interior region 15 through which a portion of a decorative element may be seen after final construction of the ornament. In some embodiments, the rear face of the half of an ornamental member may have a channel 24 for receiving a portion of a decorative element. In some embodiments, the halves of the ornamental member may have one or more prongs or recesses 23, the prongs or recesses for facilitating coupling of a snap-in ring 40 (as may be seen viewing FIGS. 7 and 15). In some embodiments, the half of the ornamental member has a prong, where the snap-in ring would have a recess (as may be seen, for example, in the embodiment depicted in FIGS. 3b and 5a). In different embodiments, the half of the ornamental member has a recess, and the snap-in ring would have a prong (as may be seen, for example, in the embodiment depicted in FIGS. 13d and 15). In some embodiments, the ornament 1 has only a single snap-in ring in the front face of the ornament. Even though the rear half of the ornamental member may have prongs or recesses for coupling a snap-in ring to the rear face of the ornament, a snap-in ring is not required to be coupled with the rear face. In an alternative embodiment, one half of the ornamental member has prongs or recesses for facilitating coupling of a snap-in ring, and the other half does not.

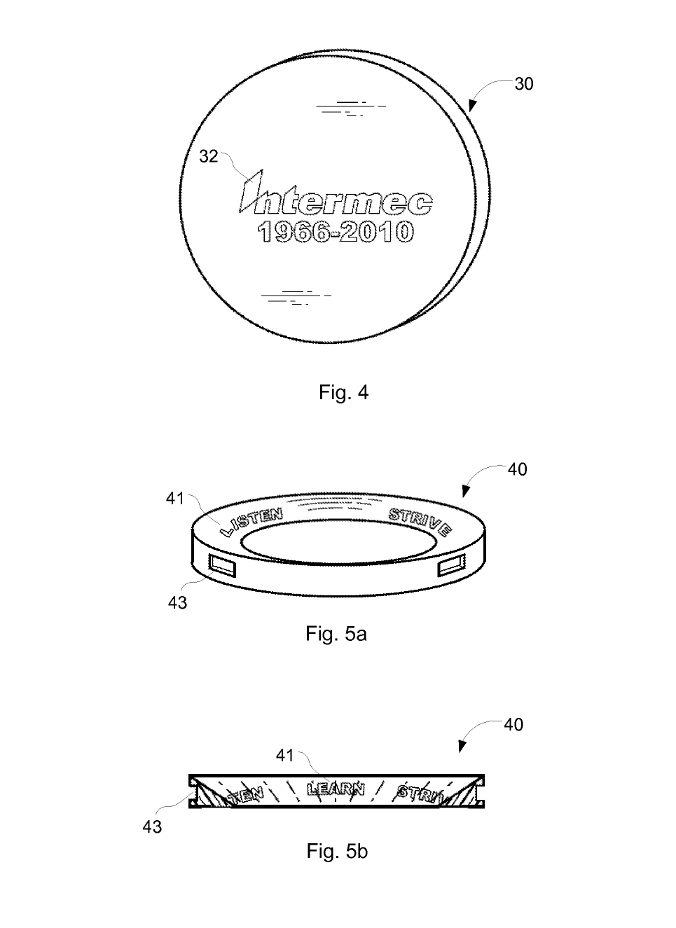

FIGS. 4 and 14 are perspective views of decorative elements of a couplable ornament, in accordance with different embodiments of the invention. As has been previously described elsewhere herein, in some embodiments a decorative element 30 is sandwiched between halves of the ornamental member. As has been previously described elsewhere herein, in some embodiments, the decorative element has a design 32, which may be a graphic design, words, images or other visually appealing element or elements. As has been previously described elsewhere herein, in some embodiments the decorative element is a substrate, or is a surface on which the design may be printed, screen, engraved, embedded, or otherwise applied using other processes disclosed elsewhere herein or with any other process.

FIGS. 5a and 5b are a perspective view and a cutaway side view of a snap-in ring of a couplable ornament, in accordance with an embodiment of the invention. FIG. 7 is an exploded view of a couplable ornament, in accordance with an embodiment of the invention. FIG. 15 is a perspective view of a snap-in ring of a couplable ornament, in accordance with an embodiment of the invention. As has been previously described elsewhere herein, in some embodiments a snap-in ring may have words 41, or a design or other visually appealing element, which may be formed and applied in any manner disclosed herein. In some embodiments, a snap-in ring may have a beveled appearance along the interior of the ring, as can be seen in FIGS. 5a and 5b. In different embodiments, a snap-in ring may, upon being inserted in the ornamental member, have a front face that is flush with the front face of the ornamental member, as can be seen in FIG. 15 or 11b. In some embodiments, a snap-in ring may snap into place using one or more prongs and/or recesses, wherein the prongs or recesses are disposed along the sides of the snap-in ring and one or more surfaces adjacent to the interior region of the ornamental member.

FIG. 6 is an exploded view of a couplable ornament, in accordance with an embodiment of the invention. FIGS. 16a, 16b and 16c are various exploded views of portions of a couplable ornament, in accordance with an embodiment of the invention. In some embodiments, a decorative element 30 is sandwiched between two halves of the ornamental member 22a and 22b. In some embodiments, the decorative element is thus fastened to the ornamental member. Accordingly, in some embodiments, the decorative element is at least partially embedded within an interior region of the ornamental member. Upon sandwiching the two halves of the ornamental member and decorative element together, the two halves of the ornamental member are joined, perhaps with sonic welding, glue, or other means of adhering or coupling the halves with the decorative element in between. FIG. 16b shows two halves of the ornamental member, 22a and 22b, being pressed together, and also depicts the magnets 21 embedded within the ornamental member. Particularly, as has been disclosed elsewhere herein, the magnets are placed at ¼ and ¾ lengths across the top and bottom of the ornamental member. FIG. 16b shows that the polarities of the magnets of each of the two halves, 22a and 22b, that are adjacent to one another have the same orientation, such that a positive pole lines up next to another positive pole. FIG. 16c is a cross-sectional view of the side of the sandwiched halves 22a and 22b and the decorative element 30, with the cross-sectional slice through the magnets 21 being shown, again showing the polarity of the adjacent magnets lining up next to one another. During assembly of the two halves, the halves will repel one another due to the magnetic force, until the halves are adhered and coupled. However, once the halves are coupled, the pair of magnets from adjacent halves will have a tendency to attract other ornaments.

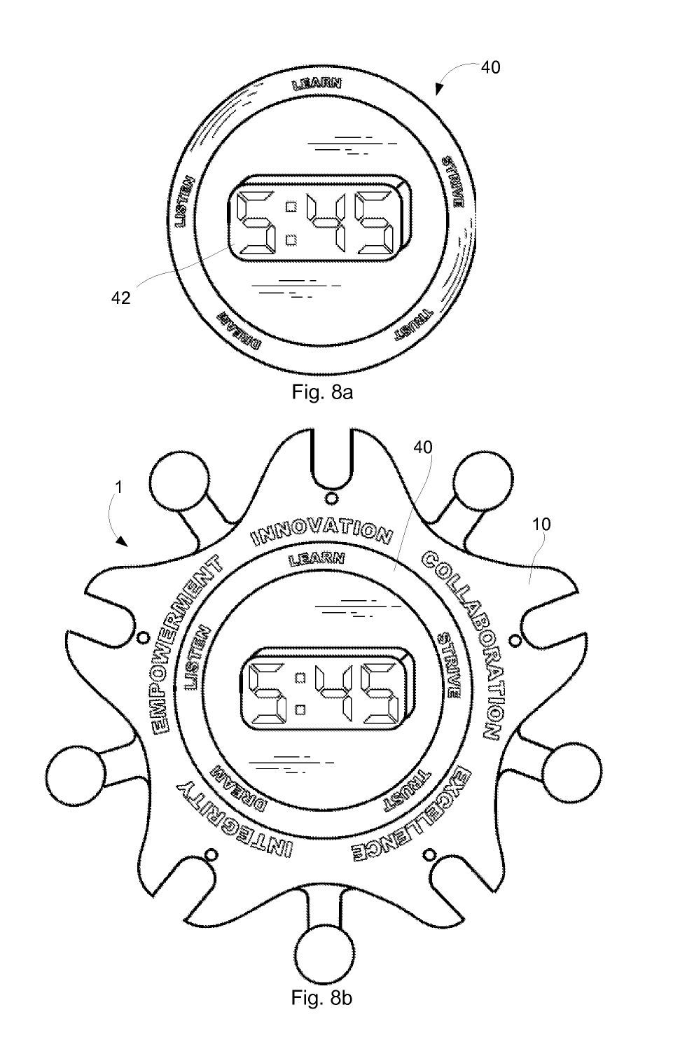

FIGS. 8a and 8b are a top view of an alternate embodiment of a snap-in ring and a top view of an alternate embodiment of a couplable ornament, in accordance with an embodiment of the invention. In some embodiments, a snap-in ring 40 may have an element different than or in addition to a design, such as a clock 42. In different embodiments, a snap-in ring may alternatively comprise a calendar, a pen holder, a dartboard, a picture frame, a compartment for storing items, a feeder, or other functional element. In some embodiments, one or more of the ornamental member or the decorative element may comprise the clock, calendar, dartboard, feeder, compartment or other functional element.

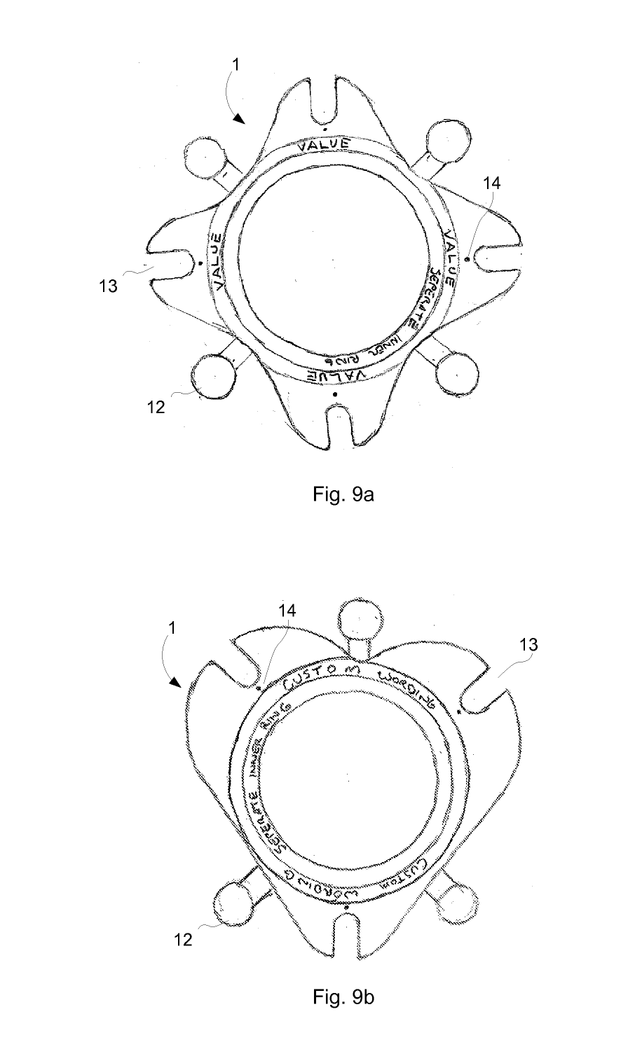

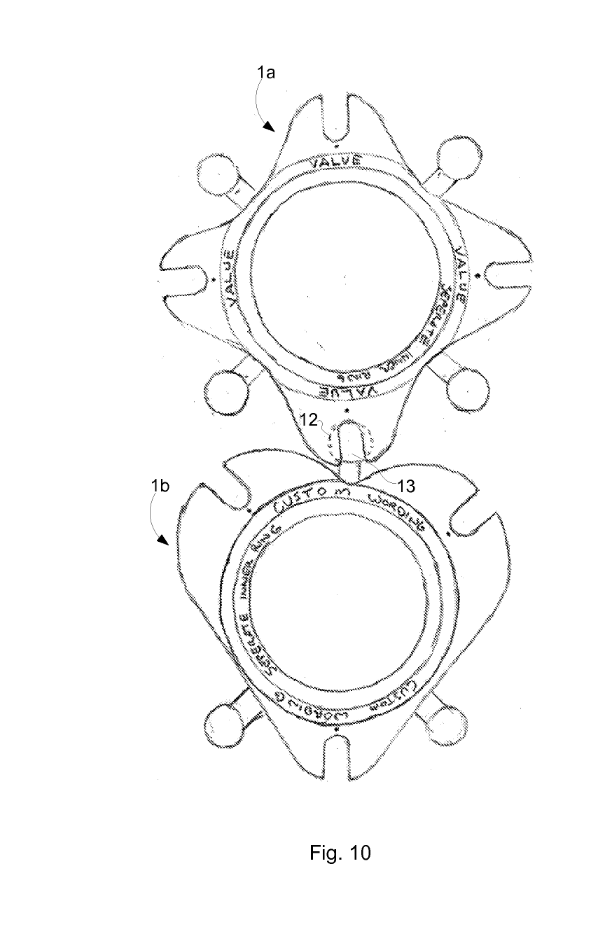

FIGS. 9a and 9b are top views of alternate embodiments of a couplable ornament, in accordance with embodiments of the invention. FIG. 10 is a top view of coupled alternate embodiments of a couplable ornament, in accordance with embodiments of the invention. As has been previously discussed elsewhere herein, in some embodiments, an ornament 1 may be substantially in the shape of a four-pointed star, a heart, or another geometric shape. In some embodiments, similarly-shaped ornaments couple with other similarly-shaped ornaments. In different embodiments, differently-shaped ornaments may have the same coupling means, including a ball-and-socket coupling means. In some embodiments, differently-shaped ornaments may couple to one another using the same coupling means.

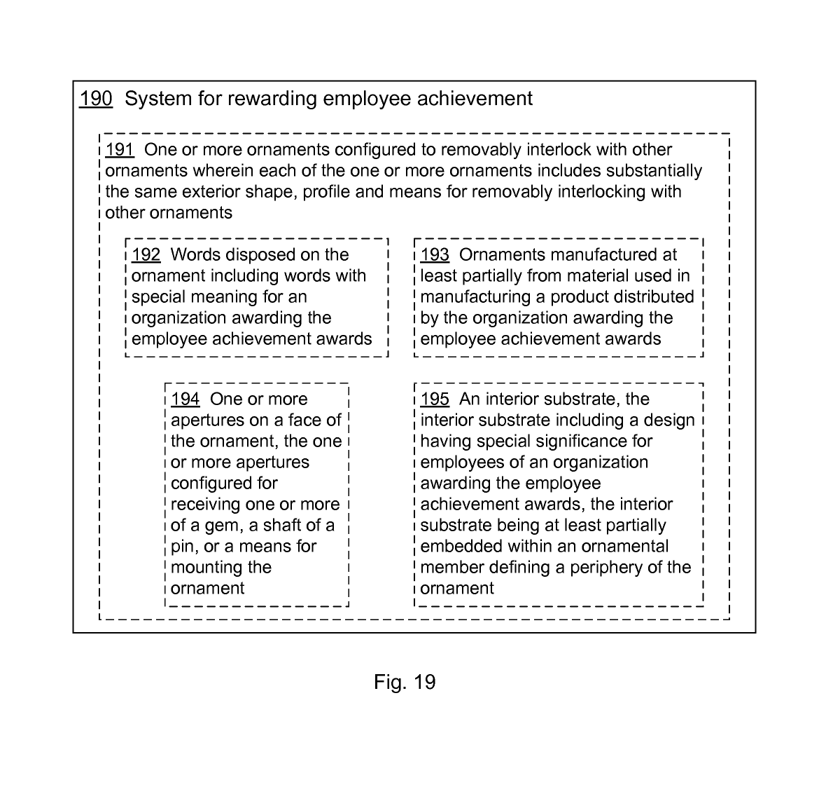

FIG. 19 is a system diagram of a system for rewarding employee achievement, in accordance with an embodiment of the invention. In some embodiments, a system for rewarding employee achievement 190 comprises one or more ornaments configured to removably interlock with other ornaments 191, wherein each of the one or more ornaments includes substantially the same exterior shape, profile and means for removably interlocking with other ornaments. In some embodiments, an ornament 191 may include at least words disposed on the ornament 192, the words including words with special meaning for an organization awarding the employee achievement awards. In some embodiments, an ornament 191 may include at least ornaments manufactured at least partially from material used in manufacturing a product distributed by the organization awarding the employee achievement awards 193. In some embodiments, an ornament 191 may include at least one or more apertures 194 on a face of the ornament, the one or more apertures configured for receiving one or more of a gem, a shaft of a pin, or a means for mounting the ornament. In some embodiments, an ornament 191 may include at least an interior substrate 195, the interior substrate including a design having special significance for employees of an organization awarding the employee achievement awards, the interior substrate being at least partially embedded within an ornamental member defining a periphery of the ornament.

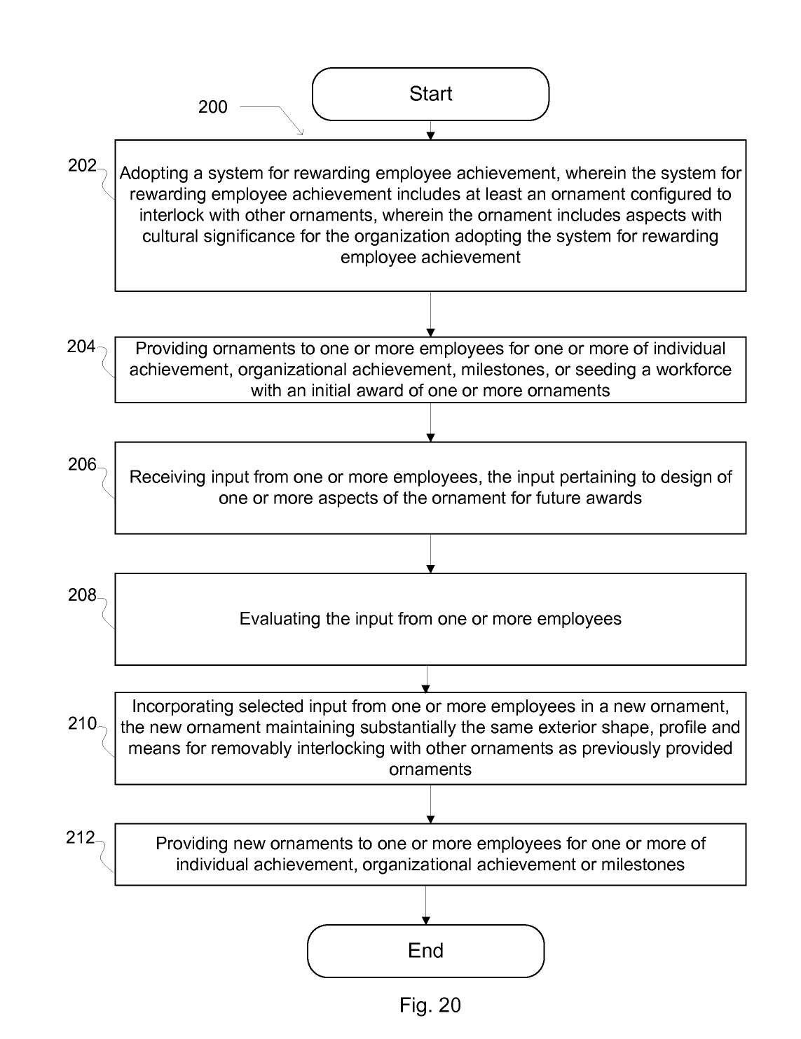

FIG. 20 is a flow diagram of a method for rewarding employee achievement, in accordance with an embodiment of the invention. In some embodiments, a method for rewarding achievement 200 may have an operation 202, an operation 204, an operation 206, an operation 208, an operation 210, and/or an operation 212. After a start operation, the method 200 moves to operation 202, which includes adopting a system for rewarding employee achievement, wherein the system for rewarding employee achievement includes at least an ornament 1 configured to interlock with other ornaments, wherein the ornament includes aspects with cultural significance for the organization adopting the system for rewarding employee achievement.

The method 200 may include an operation 204, which includes providing ornaments to one or more employees for one or more of individual achievement, organizational achievement, milestones, or seeding a workforce with an initial award of one or more ornaments.

The method 200 may include an operation 206, which includes receiving input from one or more employees, the input pertaining to design of one or more aspects of the ornament for future awards.

The method 200 may include an operation 208, which includes evaluating the input from one or more employees.

The method 200 may include an operation 210, which includes incorporating selected input from one or more employees in a new ornament, the new ornament maintaining substantially the same exterior shape, profile and means for removably interlocking with other ornaments as previously provided ornaments.

The method 200 may include an operation 212, which includes providing new ornaments to one or more employees for one or more of individual achievement, organizational achievement or milestones.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. An ornament, comprising:
an ornamental member configured to removably couple with another ornament; and
a decorative element fastened to the ornamental member.

2. The ornament of claim 1, further comprising:
one or more protrusions extending from the ornamental member, each protrusion including at least a ball, the ball at an end of the protrusion opposite the ornamental member; and
one or more sockets defined within the ornamental member, each socket configured for removably receiving a ball of another ornament.

3. The ornament of claim 2, wherein the one or more protrusions and one or more sockets comprise a ball-and-socket construction for removably coupling a first ornament with at least a second ornament.

4. The ornament of claim 3, wherein the ball-and-socket construction is configured for a first and a second coupled ornament to at least one of rotate, swivel, pivot or articulate relative to one another.

5. The ornament of claim 1, further comprising:
one or more magnets, each magnet configured for removably coupling a first ornament with at least a second ornament.

6. The ornament of claim 1, further comprising a means for removably coupling a first ornament with at least a second ornament.

7. The ornament of claim 1, wherein the decorative element fastened to the ornamental member comprises:
a decorative element that is at least partially embedded within an interior region of the ornamental member.

8. The ornament of claim 1, wherein the decorative element fastened to the ornamental member comprises:
a substrate, the substrate including a design disposed on at least a first face of the substrate.

9. The ornament of claim 1, wherein the decorative element fastened to the ornamental member comprises:
a printable surface.

10. The ornament of claim 9, wherein the printable surface is configured for an image to be printed on the printable surface, the image printed on the printable surface subsequent to manufacturing of the ornamental member and decorative element, the image printed on the printable surface prior to fastening the decorative element to the ornamental member, and wherein manufacturing of the ornamental member and decorative element occurs at a different location than a location where the image is printed and where the decorative element is fastened to the ornamental member.

11. The ornament of claim 1, wherein the ornamental member configured to removably couple with another ornament further comprises a front face and a rear face, and wherein one or more channels are disposed through the ornamental member, the one or more channels having at least a first aperture disposed through the front face.

12. The ornament of claim 11, wherein the first aperture is configured for receiving one or more of a gem or a shaft of a pin.

13. The ornament of claim 11, wherein the channel is configured for receiving a means for mounting the ornament to a structure.

14. The ornament of claim 1, further comprising:
a snap-in ring, wherein the ornamental member includes a recess configured for removably receiving the snap-in ring.

15. The ornament of claim 1, wherein the ornament is substantially in the shape of one of a five-pointed star, a four-pointed star, a rectangle, a heart, a triangle, a cross, a hexagon, or a trapezoid.

16. The ornament of claim 14, wherein the ornament is an employee achievement award given by an organization to an employee.

17. The ornament of claim 16, wherein at least one of the ornamental member, the decorative element or the snap-in ring have one or more words disposed on an exterior surface, the one or more words including words embodying values of the organization.

18. The ornament of claim 16, wherein at least a portion of the ornament is manufactured from material used in manufacturing a product distributed by the organization to non-employees.

19. A system for rewarding employee achievement, comprising:
a plurality of employee achievement awards, the employee achievement awards comprising:
one or more ornaments configured to removably interlock with other ornaments, the one or more ornaments including one or more of:
words disposed on the ornament, the words including words with special meaning for an organization awarding the employee achievement awards;
ornaments manufactured at least partially from material used in manufacturing a product distributed by the organization awarding the employee achievement awards;
one or more apertures on a face of the ornament, the one or more apertures configured for receiving one or more of a gem, a shaft of a pin, or a means for mounting the ornament; and
an interior substrate, the interior substrate including a design having special significance for employees of an organization awarding the employee achievement awards, the interior substrate being at least partially embedded within an ornamental member defining a periphery of the ornament;
wherein each of the one or more ornaments includes substantially the same exterior shape, profile and means for removably interlocking with other ornaments.

20. A method for rewarding employee achievement, comprising:
adopting a system for rewarding employee achievement, wherein the system for rewarding employee achievement includes at least an ornament configured to interlock with other ornaments, wherein the ornament includes aspects with cultural significance for the organization adopting the system for rewarding employee achievement;
providing ornaments to one or more employees for one or more of individual achievement, organizational achievement, milestones, or seeding a workforce with an initial award of one or more ornaments;
receiving input from one or more employees, the input pertaining to design of one or more aspects of the ornament for future awards;
evaluating the input from one or more employees;
incorporating selected input from one or more employees in a new ornament, the new ornament maintaining substantially the same exterior shape, profile and means for removably interlocking with other ornaments as previously provided ornaments; and
providing new ornaments to one or more employees for one or more of individual achievement, organizational achievement or milestones.
